(19) United States
(12) Patent Application Publication
(10) Pub. No.: US 2007/0022271 A1
(43) Pub. Date: Jan. 25, 2007

(54) Processor with changeable correspondences between opcodes and instructions

(75) Inventors: Kiyoko Honda, Kawasaki (JP); Nobuhiko Akasaka, Kawasaki (JP); Naoyuki Tsuno, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/222,853

(22) Filed: Sep. 12, 2005

(30) Foreign Application Priority Data
Jun. 23, 2005 (JP) 2005-183814

(51) Int. Cl. G06F 9/40

(52) U.S. Cl. 712/209

(57) ABSTRACT

A processor includes an instruction buffer operable to store an opcode, an instruction decoder configured to keep one-to-one correspondences between opcodes and instructions, to identify an instruction corresponding to the opcode received from the instruction buffer based on the correspondences, and to output a signal indicative of the identified instruction, and a control circuit configured to perform an instruction operation in response to the signal output from the instruction decoder, wherein the instruction decoder is configured such that the correspondences are changeably set.

### CROSS-REFERENCE TO RELATED APPLICATIONS

The present application is based upon and claims the benefit of priority from the prior Japanese Patent Application No. 2005-183814 filed on Jun. 23, 2005, with the Japanese Patent Office, the entire contents of which are incorporated herein by reference.

### BACKGROUND OF THE INVENTION

1. Field of the Invention

The present invention generally relates to processors and program executing methods, and particularly relates to a processor for decoding and executing instructions having variable length and a method of executing a program by use of such a processor.

2. Description of the Related Art

Each CPU (central processing unit) has a predetermined instruction set that is defined in the form of an opcode table or the like. The bit pattern (opcode) of each instruction is fixedly assigned to a corresponding operation of the CPU. Instructions selected from this instruction set are arranged in a certain order to create a program for performing a certain task. The CPU fetches the instructions of the program successively from the memory, and decodes the fetched instructions, thereby performing operations specified according to the decoded results.

If the number of instructions in the instruction set for a certain CPU is small, each instruction may be represented by use of one byte. If the number of instructions in the instruction set is large, a plurality of bytes may be necessary for each opcode in order to represent such a large number of instructions, resulting in the opcode system in which its instructions have varying lengths. In such a case, all the instructions are not represented by use of multiple bytes. Main instructions are represented by use of a single byte, with the remaining instructions that cannot be represented by a single byte (257-th instruction onwards) being defined by use of two bytes. In this case, such rules may be defined that if one byte of a fetched opcode is identified as a predetermined code, this opcode is a two-byte instruction.

A one-byte instruction requires a small area for storage in memory, and also requires a small data transfer amount at the time of instruction fetch. Because of this, frequently used instructions are generally allocated to single byte opcodes. Less frequently used instructions, on the other hand, occupy a small memory area in the executable object module, and the numbers of instruction fetches are also small. Those instructions are thus generally allocated to opcodes comprised of two bytes.

Which ones of the instructions defined in the CPU instruction set are more frequently used may vary, depending on the needs of users actually using the CPU. Even if particular types of instructions are frequently used according to the usage by a given user, such instructions may be predefined as two-byte instructions. In such a case, the memory volume necessary for storing an executable object module becomes larger, and the speed of execution becomes smaller. In the conventional CPU configurations, however, relationships between instructions and opcodes assigned thereto are permanently fixed, without the possibility of a change.

FIG. 1 is a drawing showing an example of the configuration of a related-art CPU. A CPU 10 shown in FIG. 1 is coupled via a bus 14 to a program memory 11 for storing programs, a data RAM 12, and a peripheral resource 13. The CPU 10 includes an instruction decoder 21, a sequencer (control circuit) 22, an instruction buffer 23, an ALU 24, a register set 25, a program counter 26, and a bus control unit 27.

The program counter 26 is a register that points to an address from which an instruction is fetched when instructions are fetched one after another from a memory area storing a program to be executed. As the CPU 10 fetches an instruction from an address indicated by the program counter 26, the address is loaded into to the instruction buffer 23 via the bus control unit 27. The instruction decoder 21 decodes the instruction stored in the instruction buffer 23 to supply the decoded results to the sequencer 22. Based on the decoded results supplied from the instruction decoder 21, the sequencer 22 performs operations such as setting a specified ALU mode, selecting a specified register, accessing specified data, writing to a specified register, etc.

In the instruction decoder 21, as illustratively shown in FIG. 1, each of the plurality of opcodes defined as fixed values is compared with the content of the instruction buffer 23. If the content of the instruction buffer 23 matches any one of the fixed values, a corresponding one of the plurality of comparison results is placed in a signal state indicative of match. This comparison result indicative of a match serves to identify the fetched instruction that is stored in the instruction buffer 23. As a result, a predetermined operation sequence corresponding to this instruction is performed by the sequencer 22. In the instruction decoder 21, the opcodes for comparison for the purpose of identifying the fetched instruction are provided as permanently fixed values, without the possibility of a change.

FIG. 2 is a drawing showing another example of the configuration of a related-art CPU. In FIG. 2, the same elements as those of FIG. 1 are referred to by the same numerals, and a description thereof will be omitted.

In a CPU 10A shown in FIG. 2, an instruction decoder 21A is implemented by use of a micro ROM. As an instruction is fetched and stored in the instruction buffer 23, the stored content of the instruction buffer 23 is used as an address for accessing the micro ROM. Each address of the micro ROM corresponds to an opcode, and the content stored at each address is an instruction assigned to the corresponding opcode to instruct the sequencer 22. As shown in FIG. 2, if the opcode supplied from the instruction buffer 23 is “03”, for example, the output of the micro ROM becomes “7155”. In this case, the first digit “7” may indicate to set the ALU 24 to an add mode, “15” indicating to fetch an operand, and the last digit “5” indicating to write to a register, for example. In the instruction decoder 21A, a table for identifying a fetched instruction is provided as a ROM, without the possibility of a change in the stored contents.

[Patent Document 1] Japanese Patent Application Publication No. 2003-22180

Accordingly, there is a need for a processor in which the relationships between instructions and opcodes assigned thereto are changeable, and also a need for a method of generating and executing a program with such a processor.

### SUMMARY OF THE INVENTION

It is a general object of the present invention to provide a processor and a method of executing a program that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a processor and a method of executing a program particularly pointed out in the specification in such full, clear, concise, and exact terms as to enable a person having ordinary skill in the art to practice the invention.

To achieve these and other advantages in accordance with the purpose of the invention, the invention provides a processor, which includes an instruction buffer operable to store an opcode, an instruction decoder configured to keep one-to-one correspondences between opcodes and instructions, to identify an instruction corresponding to the opcode received from the instruction buffer based on the correspondences, and to output a signal indicative of the identified instruction, and a control circuit configured to perform an instruction operation in response to the signal output from the instruction decoder, wherein the instruction decoder is configured such that the correspondences are changeably set.

According to another aspect of the present invention, a method of executing a program with a processor configured such that correspondences between instructions and opcodes are changeably set includes the steps of detecting frequency of occurrence of instructions contained in a first program, generating a second program for setting the processor such that desired correspondences between instructions and opcodes are set in response to the detected frequency of occurrence, letting the processor execute the second program so as to set the desired correspondences in the processor, and letting the processor with the desired correspondences set therein execute the first program.

According to at least one embodiment of the present invention, changeable correspondences between opcodes and instructions are provided in the instruction decoder that is an instruction analyzing unit of a processor. This makes it possible to assign one-byte opcodes to frequently used instructions in executable binary data and to assign two-byte opcodes to less frequently used instructions in the executable binary data. Accordingly, the memory volume required for storing the executable binary data becomes smaller, and the speed of instruction fetch at the time of execution becomes faster.

### BRIEF DESCRIPTION OF THE DRAWINGS

Other objects and further features of the present invention will be apparent from the following detailed description when read in conjunction with the accompanying drawings, in which:

FIG. 1 is a drawing showing an example of the configuration of a related-art CPU;

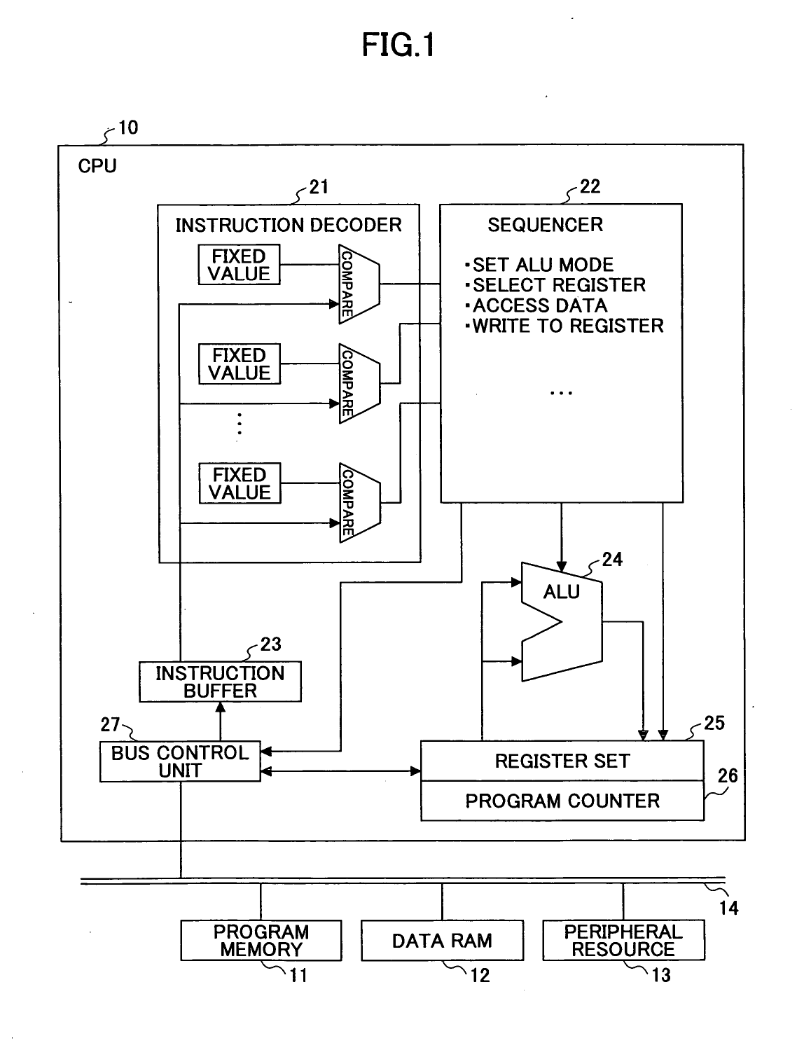

FIG. 2 is a drawing showing another example of the configuration of a related-art CPU;

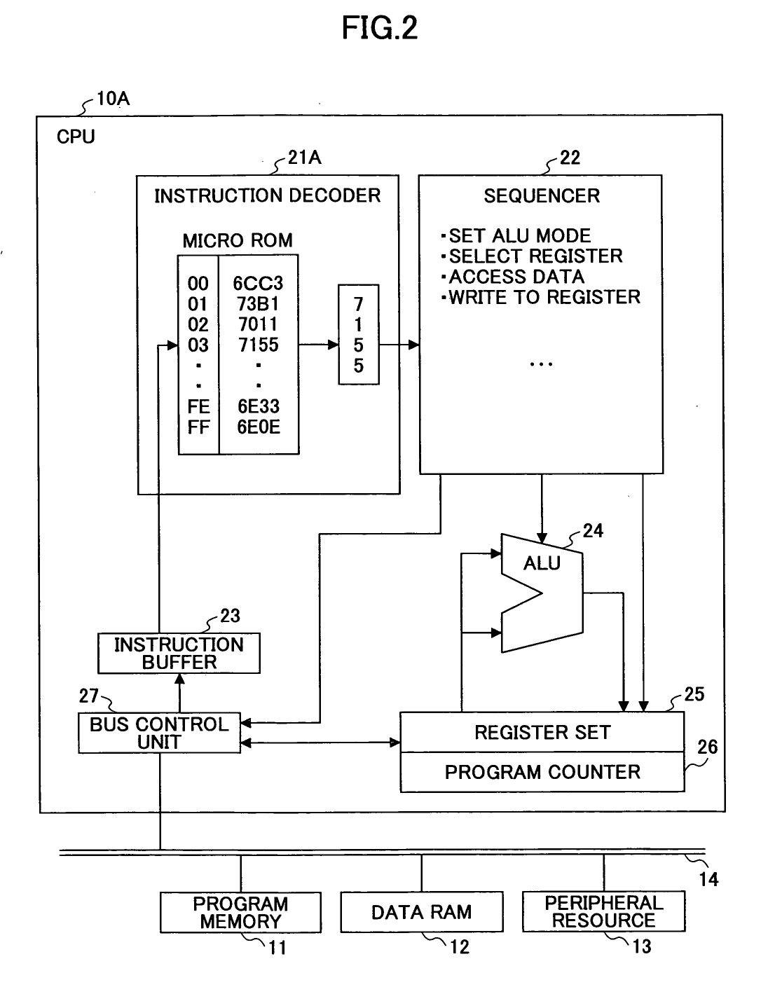

FIG. 3 is a drawing showing an example of the configuration of a CPU that is a processor according to the present invention;

FIG. 4 is a flowchart showing a process of generating executable binary data corresponding to a user application program;

FIG. 5 is a flowchart showing the detail of an instruction execution process;

FIG. 6 is a drawing showing another example of the configuration of a CPU that is a processor according to the present invention;

FIG. 7 is a flowchart showing a process of generating binary data that is executable by the CPU of FIG. 6; and

FIG. 8 is a flowchart showing the detail of an instruction execution process.

### DESCRIPTION OF THE PREFERRED EMBODIMENTS

In the following, embodiments of the present invention will be described with reference to the accompanying drawings.

In a processor according to the present invention, an instruction analyzing portion of the instruction decoder is configured such that correspondences between the opcodes and the instructions are changeable. Further, in order to set desired correspondences between the opcodes and the instructions in the instruction analyzing portion of the instruction decoder, an executable object program is generated such that its binary data includes a setting program for performing a desired setting to the instruction analyzing unit. Such binary data of an executable object format is generated when a program to be executed is compiled, assembled, and linked.

Specifically, instructions that are frequently used (frequently appear) are identified in a user application program to be executed. Then, a setting program for setting correspondences between opcodes and instructions is generated such that the instructions identified as frequently used are assigned to one-byte opcodes, and that less frequently used instructions are assigned to two-byte opcodes. This setting program is linked and assembled with the user application program, thereby generating executable binary data. When this binary data is to be executed, the processor fetches each instruction in the binary data, and the instruction decoder of the processor decodes each instruction for execution.

First, the setting program is executed. According to the instructions of the setting program, correspondences between opcodes and instructions in the instruction analyzing unit are set to desired correspondences. Here, all the correspondences between the instructions and the opcodes are not provided as changeable, and part of the correspondences between the instructions and the opcodes is provided as fixed correspondences. The instructions corresponding to such fixed opcodes are used to write the setting program. With this provision, it is possible to execute the setting program based on the fixed correspondences even when the changeable correspondences between the opcodes and instructions are not yet defined in the instruction analyzing unit. After this, the user application program is executed according to the correspondences between the opcodes and the instructions that are defined in the manner described above.

In this manner, the present invention provides changeable correspondences between opcodes and instructions in the instruction analyzing unit of a processor. This makes it possible to assign one-byte opcodes to frequently used instructions in executable binary data and to assign two-byte opcodes to less frequently used instructions in the executable binary data. Accordingly, the memory volume required for storing the executable binary data becomes smaller, and the speed of instruction fetch at the time of execution becomes faster.

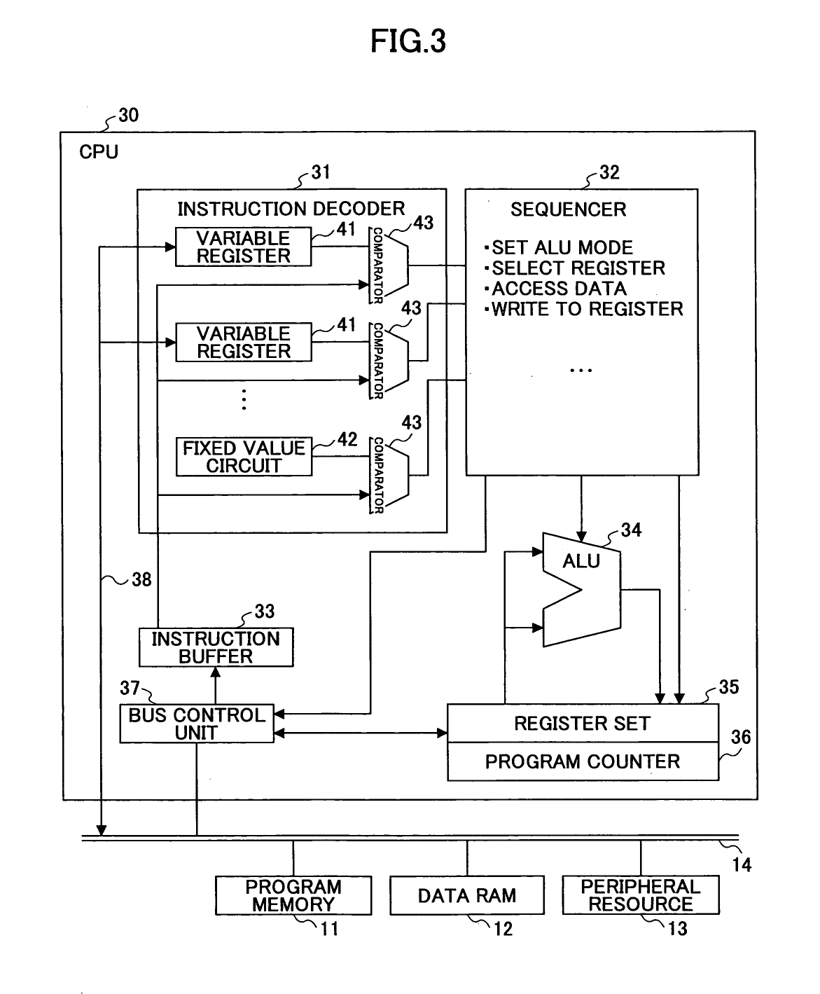

FIG. 3 is a drawing showing an example of the configuration of a CPU that is a processor according to the present invention. A CPU 30 shown in FIG. 3 is coupled via the bus 14 to the program memory 11 for storing programs, the data RAM 12, and the peripheral resource 13. The CPU 30 includes an instruction decoder 31, a sequencer (control circuit) 32, an instruction buffer 33, an ALU 34, a register set 35, a program counter 36, a bus control unit 37, and an internal bus 38.

The program counter 36 is a register that points to an address from which an instruction is fetched when instructions are fetched one after another from a memory area (program memory 11) storing executable binary data to be executed. As the CPU 30 fetches an instruction from an address indicated by the program counter 36, the address is loaded into to the instruction buffer 33 via the bus control unit 37. The instruction decoder 31 decodes the instruction stored in the instruction buffer 33 to supply the decoded results to the sequencer 32. The sequencer 32 is a control circuit for performing a predetermined operation sequence corresponding to the fetched instruction based on the decoded results supplied from the instruction decoder 31, and performs operations such as setting a specified ALU mode, selecting a specified register, accessing specified data, writing to a specified register, etc.

The ALU 34 is an arithmetic logic unit, and operates under the control of the sequencer 32, thereby performing arithmetic operations such as additions and subtractions, and performing logical operations such as an inversion, an AND operation, and an OR operation. The register set 35 is a set of registers for storing data to be subjected to the operations performed by the ALU 34 and for storing data resulting from the operations performed by the ALU 34.

The instruction decoder 31 includes a plurality of variable registers 41, a plurality of fixed value circuits 42, and a plurality of comparators 43. The variable registers 41 are provided for instructions to which opcodes are settable. The setting program as previously described, when executed by the CPU 30, sets opcodes as the contents of the variable registers 41. The fixed value circuits 42 are provided for instructions for which opcodes are permanently fixed, and output the fixed opcodes to the comparators 43. The comparators 43 are provided in one-to-one correspondence to the variable registers 41 and the fixed value circuits 42. Each of the comparators 43 compares the corresponding opcode with the content of the instruction buffer 33.

When the content of the instruction buffer 33 matches any one of the opcodes, a corresponding one of the outputs of the comparators 43 is placed in a signal state indicative of match. This comparator output indicative of a match serves to identify the fetched instruction that is stored in the instruction buffer 33. As a result, a predetermined operation sequence corresponding to this instruction is performed by the sequencer 32.

Provision may be made such that the variable registers 41 are accessible for read/write operations from the CPU 30 via the bus 14 and the internal bus 38 as an area allocated to the memory space in the same manner as the registers of the peripheral resource 13 are accessible. With this provision, a register transfer instruction, register store instruction, and the like may be used without preparing special instructions added to the normal instruction set. The setting program as previously described can thus set the contents of the variable registers 41, thereby setting desired correspondences between the opcodes and the instructions in the instruction decoder 31.

In this case, the register transfer instruction, register store instruction, and the like used by the setting program are provided in the fixed value circuits 42 as permanently fixed opcodes. Instructions relating to simple data transfer such as the register transfer instruction and the like are frequently used regardless of what the user application program is. There is thus no problem even thought they are assigned to the fixed value circuits 42 as permanently fixed codes.

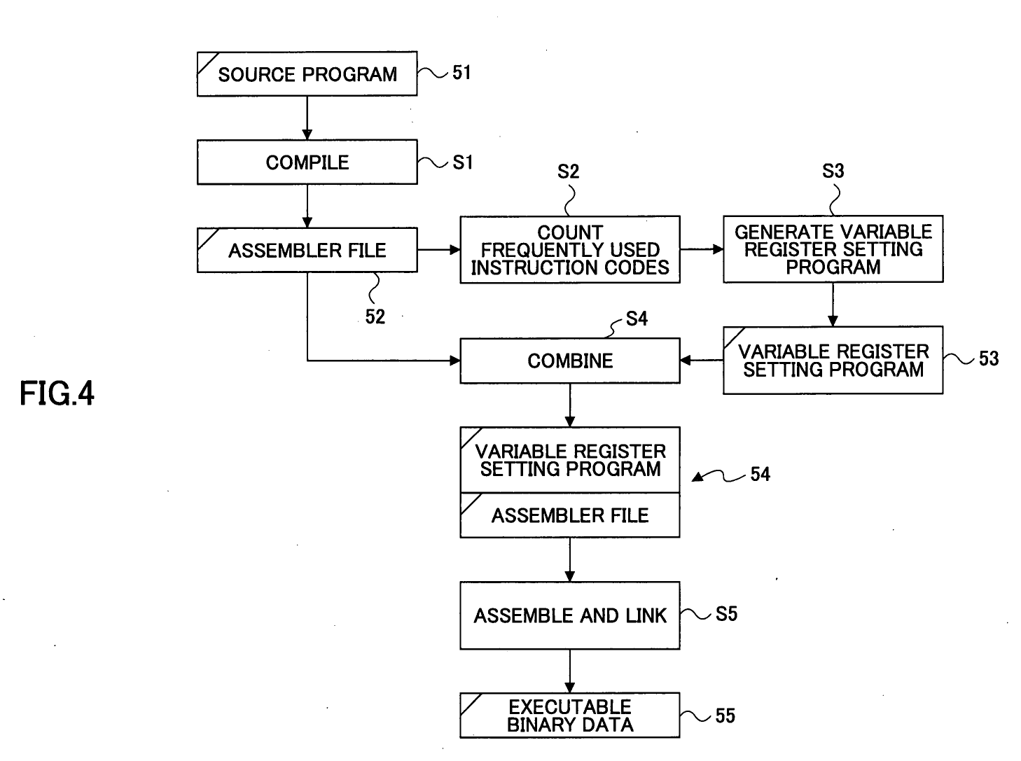

FIG. 4 is a flowchart showing a process of generating executable binary data corresponding to a user application program. At step S1 of FIG. 4, a source program 51 of the user application program is compiled by a compiler to generate an assembler file 52 described in the assembly language.

At step S2, frequency of occurrence is counted with respect to the instructions appearing in the program of the assembler file 52, and the frequently used instructions are identified. At step S3, a variable register setting program 53 is generated that serves to set opcodes to the variable registers 41 in a descending order of the frequency of use of the instructions. In so doing, one-byte opcodes are assigned first, and, then, two-byte opcodes are assigned after all the one-byte opcodes are used. With this provision, one-byte opcodes are assigned to the instructions with relatively high frequency of use, and two-byte opcodes are assigned to the instructions with relatively low frequency of use.

At step S4, the assembler file 52 and the variable register setting program 53 are linked to generate a file 54 that contains the assembler file and variable register setting program linked together. At step S5, assembling by an assembler and linking by a linker are performed to generate executable binary data 55. In this executable binary data 55, one-byte opcodes are assigned to the instructions with relatively high frequency of use, and two-byte opcodes are assigned to the instructions with relatively low frequency of use.

As a command to execute the executable binary data 55 is given, the CPU 30 fetches the instructions of the executable binary data 55, so that the instructions are successively stored in the instruction buffer 33. The instruction decoder 31 decodes the instruction stored in the instruction buffer 33. In response to the decoded result, the sequencer 32 controls the execution of the instruction.

First, a portion corresponding to the variable register setting program 53 is executed. According to the instructions of the variable register setting program 53, opcodes are set in the variable registers 41 of the instruction decoder 31. This achieves desired correspondences between the opcodes and the instructions according to the frequency of use of the instructions. In accordance with the correspondences between the opcodes and the instructions defined in this manner, thereafter, a portion corresponding to the assembler file 52 that is the user application program is executed.

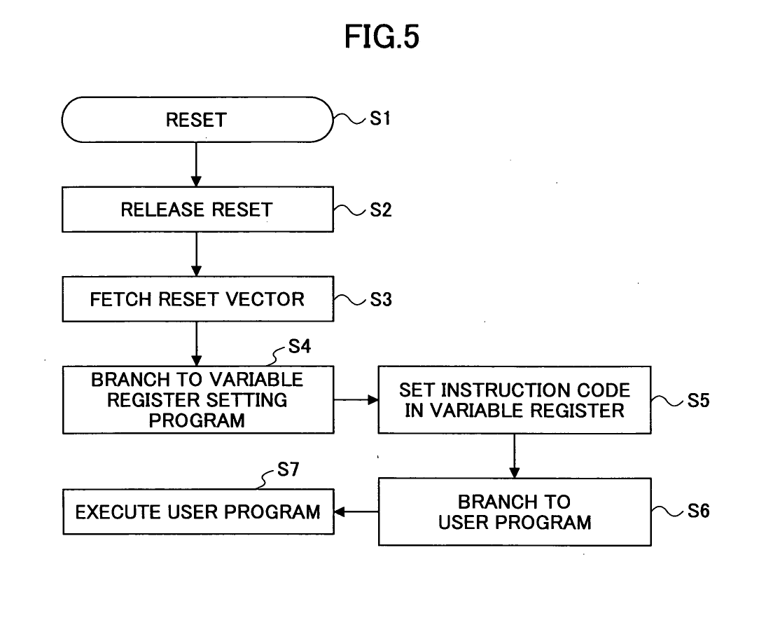

FIG. 5 is a flowchart showing the detail of an instruction execution process. At step S1 of FIG. 5, a reset is issued to the CPU 30. At step S2, the reset of the CPU 30 is released. As the reset is released, the CPU 30 fetches a reset vector at step S3. The reset vector in this case points to a start address of the variable register setting program as an address from which an instruction is to be fetched.

At step S4, the reset vector is fetched, and the program execution branches to the variable register setting program. The variable register setting program is comprised of the instructions relating to simple data transfer, and can thus be executed by use of the fixed value circuits 42 alone, without using the variable registers 41.

Specifically, the instructions of the variable register setting program are successively retrieved from the program memory 11 via the bus 14 and the bus control unit 37, and are successively stored in the instruction buffer 33. This is how the instruction fetch operation is performed with respect to the variable register setting program. During the decoding operation, the comparators 43 of the instruction decoder 31 compare the instruction stored in the instruction buffer 33 with the opcodes provided in the variable registers 41 and the fixed value circuits 42. In this case, the variable register setting program consists of the instructions relating to simple data transfer operations provided in the fixed value circuits 42, so that no problem arises even though the contents of the variable registers 41 are not yet defined.

One of the comparators 43 asserts its output signal indicating a match as the result of comparison in response to the data-transfer-type instruction stored in the instruction buffer 33. In response to the signal indicative of the match, the sequencer 32 executes the data transfer instruction. Through the execution of this data transfer instruction, a setting-purpose opcode contained in the variable register setting program is read from the program memory 11 as an operand, and is temporarily stored in a register of the register set 35 via the bus 14 and the bus control unit 37. The stored content of this register is then stored in a specified one of the variable registers 41 in the instruction decoder 31 via the bus control unit 37, the bus 14, and the internal bus 38. Alternatively, the data transfer instruction may transfer the opcode directly from the program memory 11 to the variable register 41 for storage therein.

When all the variable registers 41 have their opcodes assigned thereto, the program execution branches to the start address of the user program at step S6. After the branching, at step S7, the user program is executed in the same manner as in conventional cases.

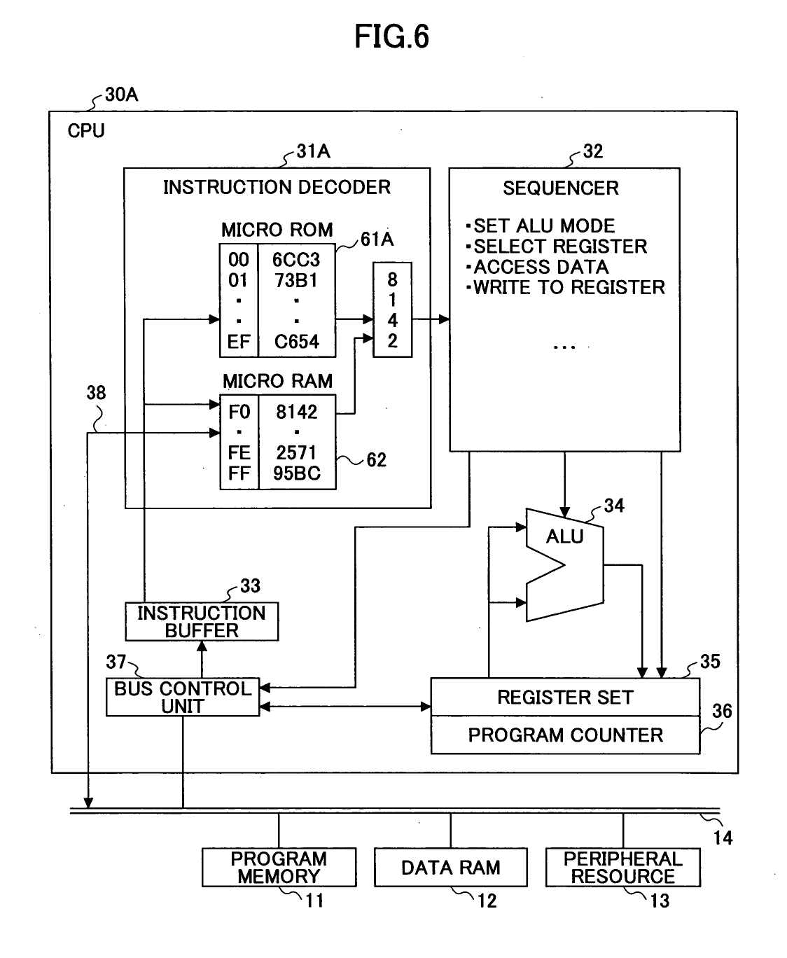

FIG. 6 is a drawing showing another example of the configuration of a CPU that is a processor according to the present invention. A CPU 30A shown in FIG. 6 is coupled via the bus 14 to the program memory 11 for storing programs, the data RAM 12, and the peripheral resource 13. The CPU 30A includes an instruction decoder 31A, the sequencer 32, the instruction buffer 33, the ALU 34, the register set 35, the program counter 36, the bus control unit 37, and the internal bus 38. In FIG. 6, the same elements as those of FIG. 3 are referred to by the same numerals, and a description thereof will be omitted.

The CPU 30A shown in FIG. 6 differs from the CPU 30 shown in FIG. 3 in the configuration of the instruction decoder. The instruction decoder 31A of the CPU 30A includes a micro ROM 61 and a micro RAM 62. Each address in the micro ROM 61 and the micro RAM 62 corresponds to an opcode, and the stored content of each address is an instruction assigned to the corresponding opcode to instruct the sequencer 32. The micro ROM 61 is provided for the instructions for which opcodes are permanently fixed, and supplies an instruction to the sequencer 32 to perform the operation of the instruction corresponding to the supplied fixed opcode. The micro RAM 62 is provided for the instructions to which opcodes are changeably assigned, and stores at a specified address (specified opcode) an instruction for a desired instruction operation so as to assign the opcode to the stored content.

As an instruction is fetched and stored in the instruction buffer 33, access to the micro ROM 61 or the micro RAM 62 is performed by using the stored content of the instruction buffer 33 as an access address. In an example shown in FIG. 6, opcodes 00 through EF are assigned as addresses in the micro ROM 61, and opcodes F0 through FF are assigned as addresses in the micro RAM 62. As shown in FIG. 6, if the opcode supplied from the instruction buffer 33 is “F0”, for example, an access operation is performed with respect to the micro RAM 62, resulting in “8142” being output. The sequencer 32 then performs operation steps such as to achieve the operation of the instruction specified by the output “8142”.

The micro RAM 62 may be configured such that it is accessible for read/write operations from the CPU 30A via the bus 14 and the internal bus 38 as an area allocated to the memory space. With this provision, a register transfer instruction, register store instruction, and the like may be used without preparing special instructions added to the normal instruction set. The setting program as previously described can thus set the contents of the micro RAM 62, thereby setting desired correspondences between the opcodes and the instructions in the instruction decoder 31A.

In this case, the register transfer instruction, register store instruction, and the like used by the setting program are provided in the micro ROM 61 as permanently fixed opcodes. Instructions relating to simple data transfer such as the register transfer instruction and the like are frequently used regardless of what the user application program is. There is thus no problem even thought they are assigned in the micro ROM 61 as permanently fixed codes.

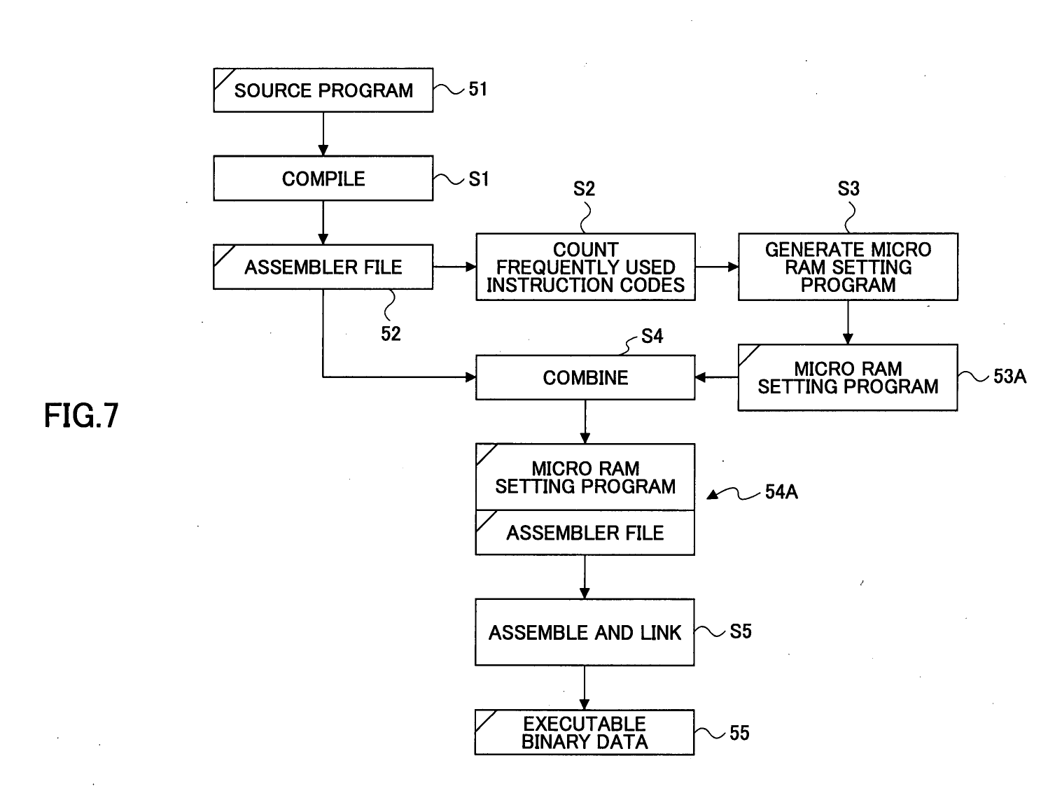

FIG. 7 is a flowchart showing a process of generating binary data that is executable by the CPU of FIG. 6. At step S1 of FIG. 7, a source program 51 of the user application program is compiled by a compiler to generate an assembler file 52 described in the assembly language.

At step S2, frequency of occurrence is counted with respect to the instructions appearing in the program of the assembler file 52, and the frequently used instructions are identified. At step S3, a micro RAM setting program 53A is generated that serves to set instructions to the micro RAM 62 in a descending order of the frequency of use of the instructions. In so doing, one-byte opcodes are assigned first, and, then, two-byte opcodes are assigned after all the one-byte opcodes are used. With this provision, one-byte opcodes are assigned to the instructions with relatively high frequency of use, and two-byte opcodes are assigned to the instructions with relatively low frequency of use.

At step S4, the assembler file 52 and the micro RAM setting program 53A are linked to generate a file 54A that contains the assembler file and micro RAM setting program linked together. At step S5, assembling by an assembler and linking by a linker are performed to generate executable binary data 55. In this executable binary data 55, one-byte opcodes are assigned to the instructions with relatively high frequency of use, and two-byte opcodes are assigned to the instructions with relatively low frequency of use.

As a command to execute the executable binary data 55 is given, the CPU 30A fetches the instructions of the executable binary data 55, so that the instructions are successively stored in the instruction buffer 33. The instruction decoder 31A decodes the instruction stored in the instruction buffer 33. In response to the decoded result, the sequencer 32 controls the execution of the instruction.

First, a portion corresponding to the micro RAM setting program 53A is executed. According to the instructions of the micro RAM setting program 53A, instructions are set in the micro RAM 62 of the instruction decoder 31A. This achieves desired correspondences between the opcodes and the instructions according to the frequency of use of the instructions. In accordance with the correspondences between the opcodes and the instructions defined in this manner, thereafter, a portion corresponding to the assembler file 52 that is the user application program is executed.

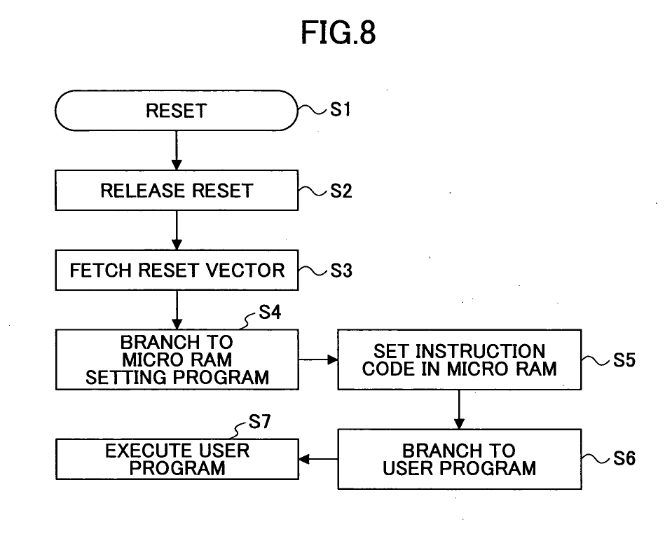

FIG. 8 is a flowchart showing the detail of an instruction execution process. At step S1 of FIG. 8, a reset is issued to the CPU 30A. At step S2, the reset of the CPU 30A is released. As the reset is released, the CPU 30A fetches a reset vector at step S3. The reset vector in this case points to a start address of the micro RAM setting program as an address from which an instruction is to be fetched.

At step S4, the reset vector is fetched, and the program execution branches to the micro RAM setting program. The micro RAM setting program is comprised only of the instructions relating to simple data transfer, and can thus be executed by use of the micro ROM 61 alone, without using the micro RAM 62.

Specifically, the instructions of the micro RAM setting program are successively retrieved from the program memory 11 via the bus 14 and the bus control unit 37, and are successively stored in the instruction buffer 33. This is how the instruction fetch operation is performed. During the decoding operation, the micro ROM 61 of the instruction decoder 31A receives the instruction (opcode) stored in the instruction buffer 33 as an address, and outputs the content (an instruction to perform an instruction operation) stored at the received address. In this case, the micro RAM setting program consists only of the instructions relating to simple data transfer operations provided in the micro ROM 61, so that no problem arises even though the contents of the micro RAM 62 are not yet defined.

In response to the instruction to perform an instruction operation, the sequencer 32 executes the data transfer instruction. Through the execution of this data transfer instruction, a setting-purpose instruction contained in the micro RAM setting program is read from the program memory 11 as an operand, and is temporarily stored in a register of the register set 35 via the bus 14 and the bus control unit 37. The stored content of this register is then stored in the micro RAM 62 of the instruction decoder 31A at a specified address (opcode) via the bus control unit 37, the bus 14, and the internal bus 38. Alternatively, the data transfer instruction may transfer the instruction directly from the program memory 11 to the micro RAM 62 for storage therein.

When the setting of instructions in the micro RAM 62 is completed, the program execution branches to the start address of the user program at step S6. After the branching, at step S7, the user program is executed in the same manner as in conventional cases.

Further, the present invention is not limited to these embodiments, but various variations and modifications may be made without departing from the scope of the present invention.

What is claimed is:

1. A processor, comprising:
an instruction buffer operable to store an opcode;
an instruction decoder configured to keep one-to-one correspondences between opcodes and instructions, to identify an instruction corresponding to the opcode received from said instruction buffer based on the correspondences, and to output a signal indicative of the identified instruction; and
a control circuit configured to perform an instruction operation in response to the signal output from said instruction decoder,
wherein said instruction decoder is configured such that the correspondences are changeably set.

2. The processor as claimed in claim 1, wherein said instruction decoder includes a rewritable memory circuit configured to store data that defines the correspondences.

3. The processor as claimed in claim 1, wherein said instruction decoder includes:
a rewritable memory circuit configured to store data that defines a portion of the correspondences; and
a content-fixed memory circuit configured to store data that defines a remaining portion of the correspondences.

4. The processor as claimed in claim 2, wherein said memory circuit is configured to be writable through access from an exterior.

5. The processor as claimed in claim 1, wherein said instruction decoder includes:
a register configured to store the opcodes; and
a plurality of comparators configured to compare the respective opcodes stored in said register with the opcode received from said instruction buffer.

6. The processor as claimed in claim 1, wherein said instruction decoder includes a RAM configured to have the opcodes as addresses, and to store the instructions as memory contents.

7. A method of executing a program with a processor configured such that correspondences between instructions and opcodes are changeably set, comprising:
detecting frequency of occurrence of instructions contained in a first program;
generating a second program for setting the processor such that desired correspondences between instructions and opcodes are set in response to the detected frequency of occurrence;
letting the processor execute the second program so as to set the desired correspondences in said processor; and
letting the processor with the desired correspondences set therein execute the first program.

8. The method as claimed in claim 7, wherein the step of generating the second program includes a step of setting the desired correspondences by assigning one-byte opcodes to the instructions having relatively high frequency of occurrence and assigning two-byte opcodes to the instructions having relatively low frequency of occurrence.

9. The method as claimed in claim 7, further comprising a step of converting the first program into executable data according to the desired correspondences, wherein said step of letting the processor with the desired correspondences set therein execute the first program lets the processor with the desired correspondences set therein execute the executable data.

10. The method as claimed in claim 7, wherein said step of generating the second program generates the second program by only using instructions for which correspondences between instructions and opcodes are fixed in the processor.
